(19) United States
(12) Patent Application Publication
(10) Pub. No.: US 2011/0022428 A1
(43) Pub. Date: Jan. 27, 2011

(54) Modelling a transport market

(76) Inventor: Roger Allen Parker, Shoreline, WA (US)

Correspondence Address: BRINKS HOFER GILSON & LIONE, P.O. BOX 10395, CHICAGO, IL, 60610, US

(21) Appl. No.: 12/586,387

(22) Filed: Sep. 21, 2009

Related U.S. Application Data
(60) Provisional application No. 61/271,932, filed on Jul. 27, 2009.

(51) Int. Cl. G06Q 50/00; G06Q 10/00

(52) U.S. Cl. 705/6; 705/348; 705/5

(57) ABSTRACT

A system, method or computer simulates a transport environment by providing a plurality of transport routes within a transport environment. Each transport route has a set of parameters providing a plurality of itineraries, each having one or more transport routes selected from the plurality of transport routes and itinerary properties including the parameters of the one or more transport routes within the itinerary. A plurality of software agents corresponding to passengers is provided. The software agents include an itinerary selector configured to select one of the plurality of itineraries based on a comparison of the itinerary properties and a set of passenger requirements. Information describing the simulated transport environment, following selection of itineraries by the software agents, forms an output.

### FIELD OF THE INVENTION

The present invention relates to a system and method for modelling a transport market and in particular the modelling of demand within the airline market.

### BACKGROUND OF THE INVENTION

Each player in the airline passenger market—airlines and airports, in particular—can only really understand its own operations, since it only has access to full quantitative information about these. It can know very little, in detail, about the performance of its competitors. Since it is a connected marketplace, where changes in the timing or pricing of one flight generally affect the environment of many other flights, it is very difficult for such players to make good decisions about new services, etc. An example should make this clearer.

Many passengers choose itineraries that consist of connecting flights. Someone wanting to go from Reading, UK, to Cincinnati, Ohio might find no direct flight from her preferred airport, London Heathrow, and might choose to make a connection in Boston or New York—or any of several other possible places—in preference to travelling to Gatwick by road or rail, even though there is direct service from London Gatwick to Cincinnati. If a preferred flight is full, this will not only affect her choice, but when she buys an alternative itinerary she may affect the choice of apparently unconnected travellers: by taking the last transatlantic seat on a flight she might, for example, affect the choice available to someone wanting to go from Munich, Germany, to Indianapolis, Ind. This connectedness makes it difficult to model the market and forecast the effect of changes in schedules and/or the economic environment.

Understanding the airline passenger market is similar to understanding weather. Local meteorological measurements can lead to quite good short-term local forecasts. However, because a storm in one part of the world not only greatly affects nearby weather but also to some extent affects the weather around the globe, long-term forecasts were poor until technology made it possible to simulate the global weather system. Weather is globally interconnected: simulating it for Europe alone cannot lead to much better forecasts for Italy than simulating it for Italy alone. However, when technology eventually allowed simulation of the entire global weather system, the quality of long-term forecasts rapidly began to get better. This improvement will continue as the size of the chunks of sky that are modelled decreases, with associated improvements coming from additional measurements of wind, temperature, etc.

Moving back to airline passengers, the main problem is that there has been no simulation of the market known to take account of its global connectedness: sometimes known as the network problem. There is a second problem associated with the data—or, rather the lack of it—available from the distribution channels used by airlines. The Virtual M1nds Airline Virtual Market solves both these problems. Therefore, there is required a method or system that overcomes these problems.

### SUMMARY OF THE INVENTION

In accordance with a first aspect there is provided a system, method or computer for simulating a transport environment comprising the steps of:

providing a plurality of transport routes within a transport environment, wherein each transport route has a set of parameters;

providing a plurality of itineraries each having one or more transport routes selected from the plurality of transport routes and itinerary properties including the parameters of the one or more transport routes within the itinerary;

providing a plurality of software agents corresponding to passengers, the software agents including an itinerary selector configured to select one of the plurality of itineraries based on a comparison of the itinerary properties and a set of passenger requirements; and

outputting information describing the simulated transport environment following selection of itineraries by the software agents.

The transport market may be the airline market, for example. The transport details may be flight details, for example.

Further software agents may be present having other functions such as supplying itineraries to be selected, transport scheduling and revenue monitoring, for example.

The simulation may be executed to emulate a number of days leading up to one or more particular departure dates. Therefore, the selection of itineraries over time may be modelled. The requirements or factors for each software agent may allow for late bookings near to departure date (e.g. last minute business trips) or early bookings corresponding to real-world long-term holiday plans, for example.

In a particular example implementation, the system comprises a model of an airline network, which may be the global airline network made up of all or substantially all airlines and scheduled flights. This model or emulation may also include transport details in the form of information regarding the capacity of particular aircraft cabins, the instantaneous cost of particular seats (seat pricing may be fixed or dynamic and so may vary up until departure time), the configuration of aircraft, i.e. destination, the number of classes and capacity of each seat class, and the schedule of each flight including arrival times, departure times and departure airport. The model may be built within a computer system in the form of a computer programme and database or run across a network, for example.

Acting on or performing within this model is a plurality of software agents representing individual passengers, groups of passengers or entities that may make ticket-buying decisions for these passengers. The selection of itineraries may be based on particular requirements or factors. These software agents exhibit, simulate or model the behaviour of passengers or groups of passengers. This behaviour may be based upon several factors or requirements including any one or more of: trip origin and destination; desired departure time; desired arrival time; maximum willingness-to-pay for a single ticket or itinerary; number of passengers travelling together; and trip purpose (business or pleasure). Further factors may include utility factors such as: carrier preference; previous experience of transport choice; loyalty programme membership; number of days to travel date and level of service required. In particular, the carrier may be any airline and the loyalty membership may be a frequent-flyer membership.

The system may further include a mechanism or method for generating a set of available itineraries formed from one or more journey legs. The itineraries may be included prior to a particular simulation. For instance, a trip origin and destination may be linked by a single non-stop flight or may include a less direct route including several legs and changes or stopovers. Each option may form a particular itinerary having its own parameters including total travel time, overall cost, number of legs, carrier used, etc. The software agents may use these factors to choose or select a particular itinerary. For example, the software agent may decide on a more expensive single leg itinerary for a short business trip or may decide to book a less expensive multiple leg journey for a leisure trip with a lower maximum willingness-to-pay. Such factors may be weighted according to importance.

The software agent may further base itinerary selection using utility functions or random utility theory.

As software agents choose and book itineraries, available seats may be used up as departure time approaches. As flights or classes within flights become full, the number of itineraries available to the remaining software agents for a particular date may reduce. These effects may also be included in the model. Optionally, as seats in a higher class are sold or used up, more seats may be added to that class from lower-priced seats and visa versa.

The software agents may include probability factors for making decisions on purchasing particular itineraries.

The system may provide various outputs including estimated revenue and profitability for particular transport items (e.g. flights) and a carrier's total revenue and profitability. The model may be amended and the system repeated to assess how the amendments affect each carrier and their profitability. Therefore, the interconnectability of the global transport or airline network may be simulated and modelled under different scenarios. Flights may be added or removed. Airlines may introduce new destinations or remove existing destinations. Furthermore, new carriers or airlines may be introduced. By modelling the whole marketplace, the effect of such amendments on any or all carriers or airlines can be simulated and presented as results.

The results may be stored in a database or as a computer file. The results may be viewed or displayed using two or three-dimensional images or graphics, for example.

The model may be calibrated to improve its accuracy. Calibration may include changing aspects of the model or the software agents until the system's outputs correlate more closely with real-world data, where available.

In a particular example, the proportion of the total demand for any carrier or airline may be changed iteratively. This may also include changing any market that is associated with any known or measurable distribution channel. For example, a first carrier may sell more via its own website for one city-pair than for another, and these proportions are likely to be different from those of a second carrier. Such iterations may continue until execution of the model yields results that match what can be observed in reality. The ticket provider may also be a software agent or many such software agents representing different ticket sources.

According to a second aspect of the present invention there is provided a system, method or computer for generating itineraries for a transport environment comprising the steps of:

providing a plurality of transport routes within a transport environment;

ordering the plurality of transport routes according to departure time to form a departure set;

ordering the plurality of transport routes according to arrival time to form an arrival set; and

matching a transport route from the departure set with a transport route from the arrival set by comparing the destinations of the departure transport routes with the origins of the arrival transport routes. The transport routes may be generated or gathered from external sources such as airline schedules, for example.

Optionally, the method may further comprise the step of matching further transport routes to form two or more stop itineraries.

The method may be implemented in an automated manner using a computer system, for example. The ordering steps may use sorting algorithms.

According to a third aspect of the present invention there is provided a computer program product or signal comprising instruction steps for operating on a computer to simulate a transport environment, the instruction steps comprising:

providing a plurality of transport routes within a transport environment, wherein each transport route has a set of parameters;

providing a plurality of itineraries each having one or more transport routes selected from the plurality of transport routes and itinerary properties including the parameters of the one or more transport routes within the itinerary;

providing a plurality of software agents corresponding to passengers, the software agents including an itinerary selector configured to select one of the plurality of itineraries based on a comparison of the itinerary properties and a set of passenger requirements; and

outputting information describing the simulated transport environment following selection of itineraries by the software agents.

The methods may be implemented within a computer environment such as a single desktop computer or a multi-processor server or virtual server operating on a network, including grid and cloud-based computing. Such computer systems may run a suitable operating system such as for example, Microsoft Windows®, Apple OS X, Linux or Unix. These systems may have internal permanent storage and may be connected to external networks such as the Internet, for example. Data may be stored as data files or within a database such as, for example, Microsoft SQL-Server, Oracle or MY-SQL.

### BRIEF DESCRIPTION OF THE FIGURES

The present invention may be put into practice in a number of ways and embodiments will now be described by way of example only and with reference to the accompanying drawings, in which:

FIG. 1 shows a flowchart of high or top level steps of an example simulation method, including preprocessing, scenario definition, execution and analysis steps, given by way of example only;

FIG. 2 shows a flowchart including further details of the preprocessing step of FIG. 1 and including calibration and estimation steps;

FIG. 3 shows a flowchart including further details of the scenario definition step of FIG. 1 and including editing steps;

FIG. 4 shows a flowchart including further details of the execution step of FIG. 1;

FIG. 5 shows a flowchart including further details of the analysis step of FIG. 1;

FIG. 6 shows a flowchart including further details of the scenario definition of FIG. 3 (see also Appendix C);

FIG. 7 shows a flowchart including further details of the estimations steps of FIG. 2;

FIG. 8 shows a flowchart including further details of the estimation steps of FIG. 2;

FIG. 9 shows a flowchart including further details of the simulation of FIG. 4; and

FIG. 10 shows a flowchart including further details of the simulation of FIG. 9;

It should be noted that the figures are illustrated for simplicity and are not necessarily drawn to scale.

### DETAILED DESCRIPTION OF THE PREFERRED EMBODIMENTS

Example implementations are described in appendices, which form part of the present application and are in any case, incorporated by reference. These appendices are unpublished unless otherwise specified. Note that some of these appendices refer to the model discussed herein by working names such as AMS and AirVM.

Appendix A describes in further detail the operation and composition of the software agents.

Appendix B illustrates how selection of individual flights and itineraries affects other parts of the network and how this is simulated by interacting software agents.

Appendix C describes in further detail how factors and requirements are used by passenger software agents to form decisions and select itineraries.

Appendix D describes how an airline market may be modelled from incomplete data or a partial knowledge of air travel demand.

Appendix E describes advantages and benefits of the software agent based system over prior art methods.

Appendix F describes how the accuracy of a software agent based system may be tested and calibrated.

Appendix G describes in further detail an example implementation of the model and software agents.

Appendix H describes an example implementation of the selection and decision functionality provided within software agents.

Appendix I compares aspects of the present system and method with previous techniques.

Appendix J describes the empirical nature of fare distributions for use in an example implementation.

Appendix K describes an example method and system for generating itineraries.

An embodiment is known as AirVM Airline Passenger Virtual Market (AirVM) and is concerned with the airline industry. AirVM is provided as an example. However, the invention may be implemented to simulate any transport environment.

The figures show schematically the logic flow of the AirVM Airline Passenger Virtual Market. It covers in broad brush the entire system, but drills down in detail to show important steps in the methods forming AirVM and that are applied to the execution of the simulator. However, more routine tasks, such as result reporting or user input, are only discussed briefly since implementation of such capability can be accomplished a number of ways, and no unique constructions are required. Each process identified in the flowcharts is described. The processes or method steps are discussed in numerical order, not necessarily in the logical order specified by each flowchart. Processes in a flowchart are numbered from upper left to lower right, for ease in locating the entry within the flowchart.

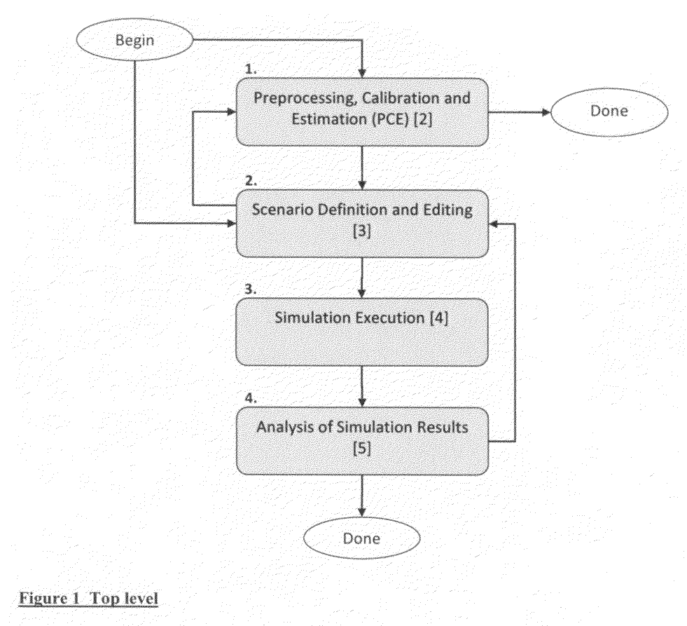

Four major process groups are shown in FIG. 1. Each of these is delineated at Logic Level 2, as well, with the existence of a lower-level schematic being indicated by shading and the corresponding Figure number being shown in square brackets, [ ]. Those discussions proceed in numerical order. When one of these processes warrants an additional level of logic, it is discussed under that general topic. One process requires a Logic Level 4 diagram (Process 3.11.7, the Pag Choice process) and it is presented in numerical order under the discussion of process 3.11).

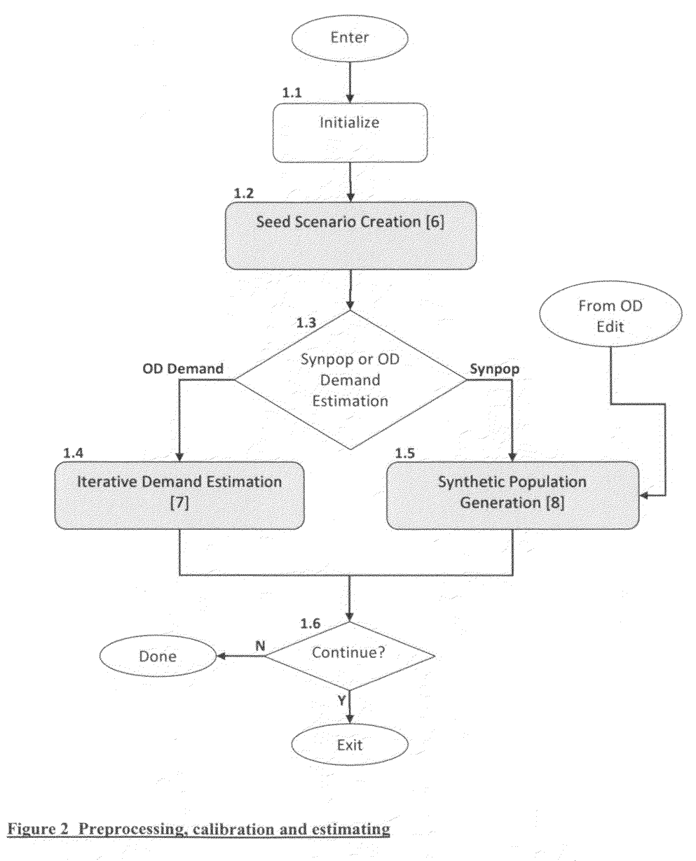

1. Preprocessing, Calibration and Estimation (PCE): This logic covers preparation of raw data, calibration of mathematical models (estimating the parameters of such models), estimation of Origin-Destination (OD) demand, and creation of synthetic populations of passenger agents (pags). A synthetic population is a collection of passenger agents, which represent all the passengers that will travel on the world's commercial air passenger network for a specified time period—nominally a week. PCE activities are carried out by a system administrator, and are not available to system users. The system can exit from this process, or continue to carry out further work. FIG. 2 contains the Level 2 Logic for process 1.

1.1 Initialize: Establish an initial value for several internal parameters, such as location of key files. Most are read from files where default values are stored. Standard computing application techniques may be used.

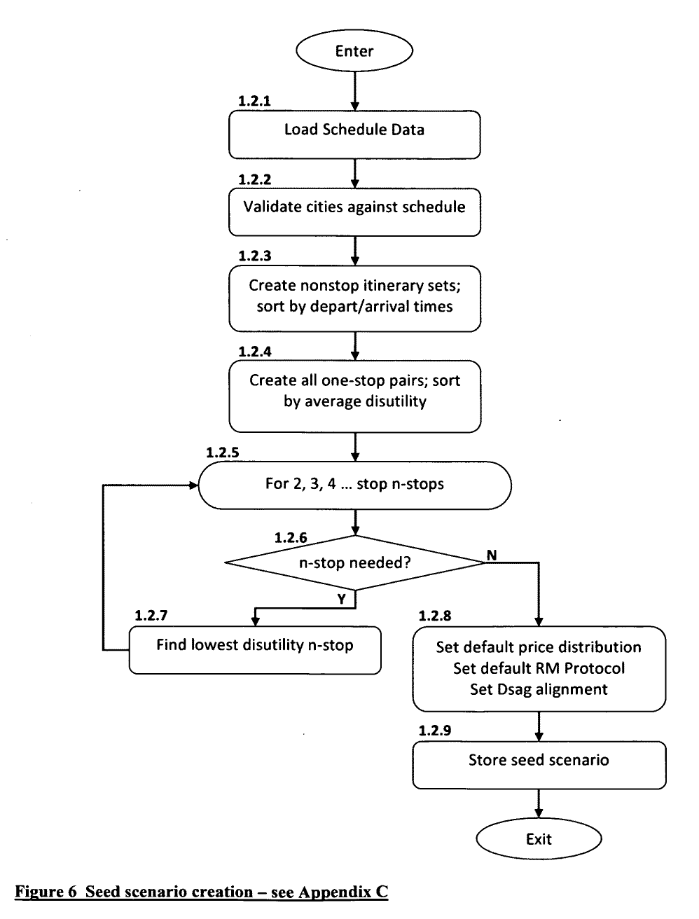

1.2 Seed Scenario Creation. A scenario may be required by AirVM. A scenario is a specific description of the world's commercial airline network. It is built from published airline schedule available from several vendors, including OAG and Innovata. The seed scenario built here is one from which further scenarios may be generated by users. The scenario contains a description of available itineraries for every OD in an OD matrix. Since the number of itineraries is likely to far exceed the amount of memory of available to current computers (some estimates put the number in the vicinity of 10¹⁴), a method may be used to restrict the number of itineraries generated. AirVM uses a passenger disutility model developed for a passenger agent choice methodology to determine the value of a proposed itinerary, and only keeps itineraries of sufficient value (as defined below). Further details of this aspect is described in Appendix C. The Level 3 Logic of FIG. 6 describes this process in detail.

1.2.1 Load Schedule Data: The data from a commercial schedule source, which describes the world's flight offerings for a given, standard time period (nominally a specified week) are loaded into AirVM. Standard database techniques are used. In this task, carriers operating for the time period are also recorded, and airline scheduling and revenue agents (arasags) are created.

1.2.2 Validate cities against schedule: Flights in the airline scheduled are compared with a list of known airports in the world to determine which OD pairs (ordered pairs of cities, with the first being the origin of the trip and the second being the destination) are served by that schedule. This results in an (empty) OD matrix.

1.2.3 Create nonstop itinerary sets; sort by depart/arrival times: For every OD that is served by one or more nonstop flights, a list is prepared of every flight that serves that OD. This is called a nonstop itinerary set. Two lists are prepared: one is sorted in ascending order by departure time (defined in terms of minutes from the start of the standard time period), and the other is sorted in ascending order by arrival time. Two lists are prepared because pags can be departure or arrival time sensitive.

1.2.4 Create all one-stop pairs; Sort by average disutility: Nonstop itinerary sets can be matched up (if the destination of one matches the origin of another), then the pair is a set of itineraries from the first's origin to the latter's destination. Every pair of flights, one from the first element of the ordered set, and one from the second, is a one-stop itinerary. This is true because the schedule is assumed to repeat once per standard time period, so multi-stop itineraries “wrap” around the end of the period. Many such pairs exist for most OD's, so the system sorts them by average passenger disutility.

Disutility may be described as negative utility. Travel may be difficult and not enjoyable. A passenger may choose an itinerary has lower disutility over another with higher disutility. The option with the highest utility is exactly the one with the lowest disutility.

1.2.5 Itinerary n-stop computation loop control: As one-stops can be created from nonstops, two-stop itineraries, three-stop itineraries, etc. can be created from lower order itinerary sets. However, the number of possible two-stop and higher-order itineraries far exceed the feasible demand for travel in that particular OD, so not all possible combinations are kept. Only the single combination with the lowest average passenger disutility may be retained, for instance.

1.2.6 n-stop needed branch: If an OD has non- or one-stop itineraries, only two-stop itineraries are calculated. No further multi-stop itineraries may be added. This is because the economics of the industry guarantees, as a practical matter, that three-stop and higher itineraries will not be needed if lower order itineraries exist (it would be uneconomical do so). So higher-order multi-stop itineraries are only defined if there are no lower order itineraries available. This branch determines if such additional itinerary sets are required. If they are, task 1.2.7 is executed. If not, control moves to 1.2.8. This branch is implemented with standard computing techniques.

1.2.7 Find lowest disutility n-stop. This task examines the possible n-stop itinerary sets and retains the one with the lowest average passenger disutility.

1.2.8 Set default price distribution, default RM protocol, Dsag alignment: After the itinerary sets are determined, each market may be given a default fare class price distribution. This is an empirical distribution function (EDF) description of the fares charged for markets of this type. The EDFs for the OD markets are estimated from data outside of AirVM. Also, default Revenue Management (RM) protocols are assigned to each flight in the scenario. These may be changed by the user. Finally, the default alignment between the number of distribution agents (dsags) and the carriers and cities they serve may be set. At the present time, only one dsag is used by default in AirVM. However, more than one dsag may be used.

1.2.9 Store the seed scenario. The scenario defined by this process is called a seed scenario because it is the basis on which other scenarios in a simulation analysis may be based. That is, the seed may be the parent of other scenarios. Several seeds can exist, generally one for each different standard time period. The parent-child structure of the scenarios guarantees comparability during data comparative analysis. The seed scenario may be stored in an internal, proprietary data structure or may be stored in other forms.

1.3 OD Demand, Synpop branch: Two options are available once a seed scenario has been created. The system administrator can create a new OD demand matrix, or define and create a synthetic population (synpop).

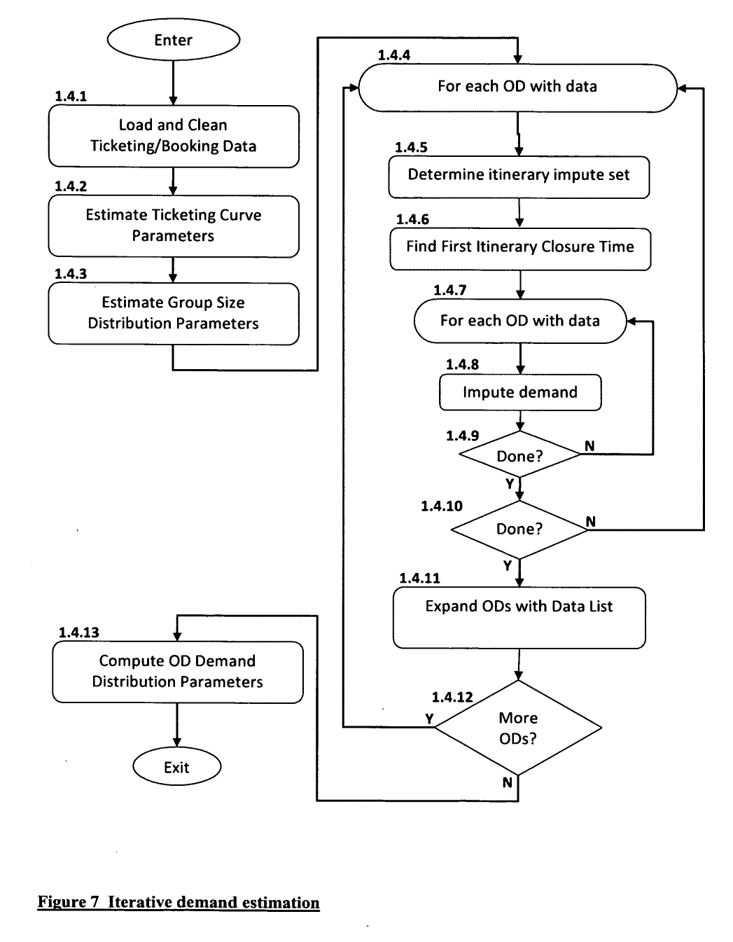

1.4 Iterative Demand Estimation: Passenger demand by origin-destination city pair is very useful for the operation of AirVM. A demand matrix (as it may be called), can be supplied externally. If, however, adequate data of the right type is available, AirVM can produce an estimate of that demand. This process contains is outlined at Logic Level 3 in FIG. 7.

1.4.1 Load and clean ticketing/booking data: The data needed for the iterative OD estimation process may be ticketing or booking data from a source such as an airline, a bank settlement plan (BSP), a global distribution system (GDS) or other such source, for example. It may contain records of individual ticket purchases, indicating the size of the group travelling, when the ticket was purchased, what itinerary was purchased, and how much was paid, etc. This task controls the loading and cleaning of these data. The ODs from the OD matrix that have data in the data set may be used to build an “OD with Data” list.

1.4.2 Estimate Ticketing Curve Parameters: Using an appropriate process, such as a compound, non-homogeneous Poisson counting process, for example, as a model, the required parameters of that model for each OD in the OD with Data list may be estimated, using standard statistical techniques.

1.4.3 Estimate Group Size Distribution Parameters: A mixed, truncated Poisson distribution may be used, for example, to represent the size of the group addressed in a particular ticketing instance. Parameters for this model are estimated directly from the data using standard statistical techniques.

1.4.4 For each OD with Data control loop: Loop control, manages tasks 1.4.5 through to 1.4.12.

1.4.5 Determine itinerary impute set: Knowledge of the probability that a passenger will choose one of a set of itineraries coupled with knowledge of the total number of passengers choosing a single itinerary of that set allows the imputation of the total demand in that OD, using the simple relation that demand for a specific itinerary is equal to the total demand times the probability of that itinerary. Thus, if data on the ODs of passengers on a given flight is known, then data is known on the demand that must be being served by other itineraries that serve those same ODs. The set of ODs that meet this criterion is called the impute set for a given flight in this example.

1.4.6 Find First Itinerary Closure Time: The number of passengers on a particular flight travelling in a specific OD market is not only a function of the probability of itinerary choice, but also of the availability of itineraries. If an itinerary is closed during the ticketing period, it is no longer available to later-ticketing passengers, and this may distort the allocation of passengers to the itineraries, invalidating the imputation discussed above. However, prior to the closure of the first itinerary in a market, the numbers of passengers represent the choice probabilities, and calculation of demand at that point is valid. This is a point in time that the first itinerary becomes no longer available is called the First Itinerary Closure Time, or FICT, in this example. The FICT may be discernable by calculating parameters of the stochastic process describing the expected ticketing rates (steps 1.4.2 and 1.4.3) sequentially through the ticketing process and noting when the parameter changes beyond a specific threshold.

1.4.7 OD imputation control loop: This loop controls the calculation of the imputed demand for each OD market for which data is available.

1.4.8 Impute demand: The demand at departure is estimated using the FICT total and the ticketing curve/group size models for the specified market.

1.4.9 Exit control of OD imputation loop: Exits when all ODs in the impute set are handled.

1.4.10 Exit control of the OD with Data loop: Exits when all ODs with Data are processed.

1.4.11 Expand ODs with Data List: The results of the estimation process above includes the determination of additional ODs for which demand data is now known. The flights (or other transport route types) that serve those ODs also serve other ODs not originally in the List. This step adds those ODs to that List.

1.4.12 Exit control of OD with Data loop: If there are no more ODs added to the list, the process moves to step 1.4.13.

1.4.13 Compute OD demand distribution parameters: OD demand is not a constant, and the imputation process can produce a set of demand estimates for a specified market. This step characterizes the distribution of the demand estimates by the computation of the first four moments of the empirical distribution, so that this natural variability can be accommodated in AirVM.

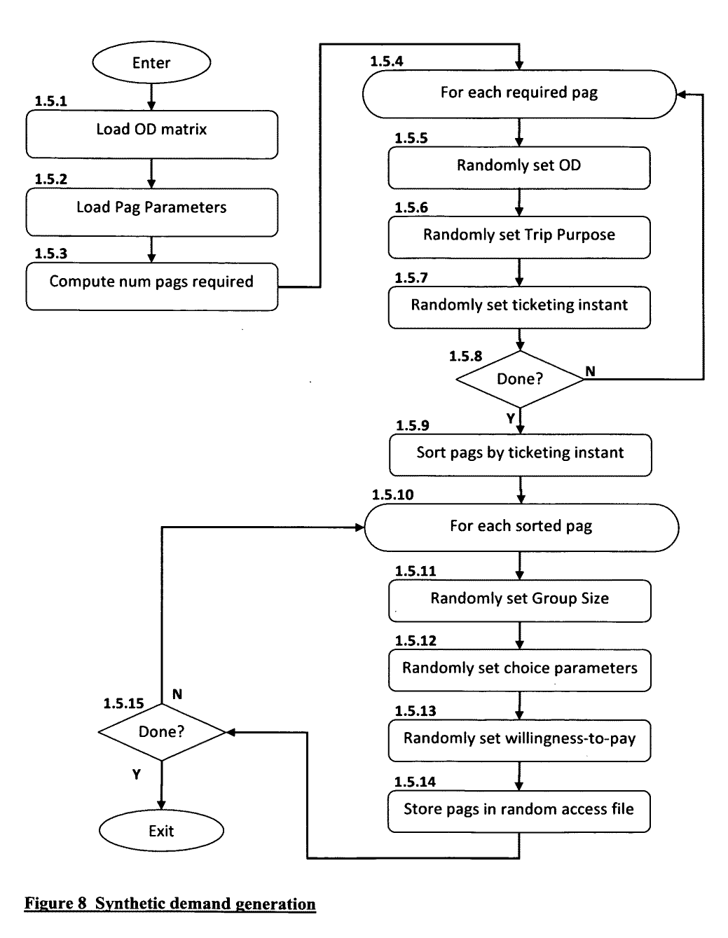

1.5 Synthetic Population Generation: Once a seed scenario has been established, and an OD demand matrix determined, the passenger agents (pags) that will be used in the simulation may be defined. A pag represents one or more tickets being sold to passengers on to travel in a specific market. The number of tickets associated with a pag is the group size. The passenger agents in AirVM have a large state space associated with them. The state space of a software agent is the area of memory, wherein the current internal state of the agent and the agent's perception of its environment are stored. Many of the parameters in the state space are set when the agent is created in the software using various models of those parameter values estimated from empirical data. These models generally themselves have parameters, which are external supplied using an input file, which may be read at run time. Then a series of random number steps determine the values that a specific pag may have. The Level 3 Logic of process 1.5 is illustrated in FIG. 8.

1.5.1 Load OD Matrix: The OD demand matrix for this synthetic population is loaded from disk storage at this step, using standard computing techniques.

1.5.2 Load Pag Parameters: A file containing parameters for the models of pag state space variables are loaded from storage. These may include parameters associated with ticketing curves, group size distributions, trip purpose and journey structure probability distributions, willingness-to-pay discrete choice parameters, ideal departure and arrival time distributions, and the mean and standard deviation of the coefficient variables for the four itinerary choice models maintained by each pag.

1.5.3 Compute number of pags required: The OD demand matrix determines how many pags are to be created, being equal to the sum of the entries in that matrix.

1.5.4 Pag pre-generation control loop: The creation of pags is a two-step process. First a “pre-pag” data structure may be created. This is then used to create the full pag. This is the control loop for the pre-generation.

1.5.5 Randomly set OD: The origin and destination of the trip to be requested by that pag is randomly set by applying a uniform random number to the discrete probability distribution of OD travel implicit in the OD matrix. Standard methods are used for this procedure.

1.5.6 Randomly set Trip Purpose: Using standard randomization methods, a trip purpose may be assigned to the pag for this trip.

1.5.7 Randomly set ticketing instant: The time before departure that the pag will request ticketing—referred to as the ticketing instant—is now set using standard randomization methods. However, the time span from which the ticketing instant is drawn may be important, and, it enables an improved method of simulation. The ticketing instant may be measured in 10ths of a second, for example, following the commencement of the ticketing period, which is nominally 90 days before the beginning of the standard week although any time frame may be used. It may continue to the 97th day following commencement, allowing for ticketing during a week-long standard time period. The ticketing instant may be drawn from a probability distribution representing the ticketing stochastic process for the trip purpose and the OD being considered, using standard methods.

1.5.8 Exit control for pag pre-generation: Exits from loop using standard procedures.

1.5.9 Sort pags by ticketing instant: This step sorts the pre-generation data structure by ticketing instant, from earliest to last. When sorted this way, the pag ticketing instant may become the simulation clock, as discussed in process 3, simulation execution.

1.5.10 Full pag creation loop: This is the control loop for the completion of the pag generation process.

1.5.11 Randomly set group size: The number of people in the group that will be ticketed by the pag may be set using standard techniques applied to the group size distribution for the specific trip purpose or OD for that pag.

1.5.12 Randomly set choice model parameters: Using the parameter distributions supplied in step 1.5.2 for the pag state space, the coefficients of the itinerary probability distribution resulting from the discrete choice model may be assigned to the pag, using standard randomization techniques. Using the distributions of ideal departure and arrival times, preferred times for this pag may be randomly selected.

1.5.13 Randomly set willingness-to-pay: Using a WTP model, a maximum fare willing to be paid by the pag for a ticket may be set using standard techniques.

1.5.14 Store pag in random access file: The pag may be stored in a random access file for use by the simulation execution processes. It is important to note that the pags are stored in ticketing instant order, with the earliest ticketing agent being first.

1.5.15 Exit control for full pag creation loop: When all pags have been created, the synthetic population creation process is complete, and the routine exits.

1.6 Continue control for PCE processing: The PCE can be entered in at least two ways: as part of the initial set up of a scenario for future processing, or as a result of an edit to the OD demand matrix. If from the OD edit, control exits to the scenario definition and editing functions of AirVM (Process 2). If not, AirVM closes down.

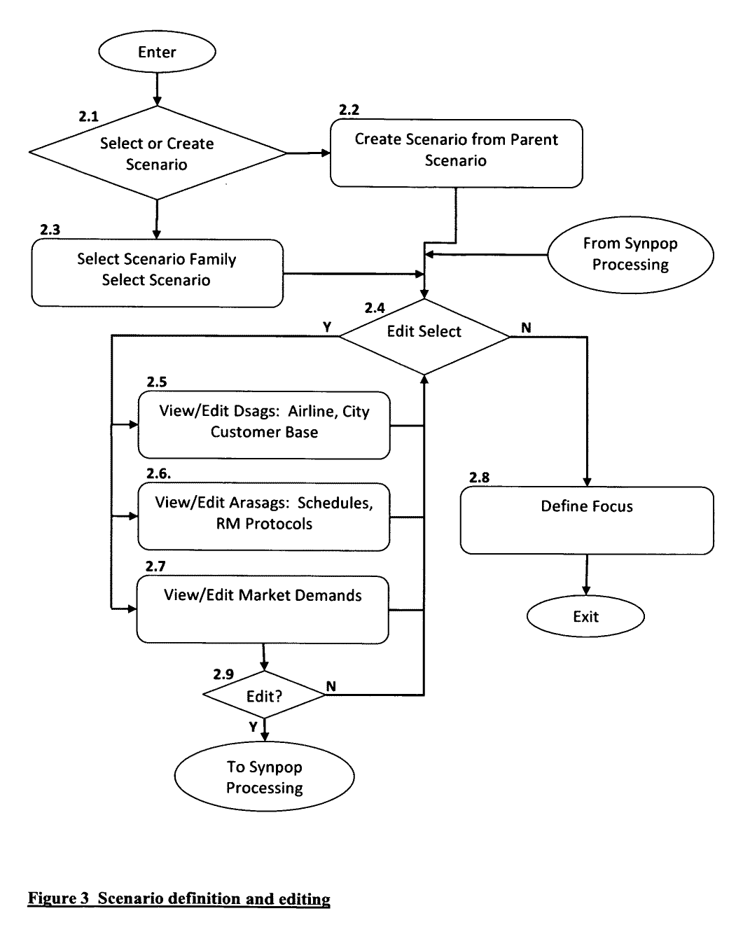

2. Scenario Definition and Editing: This activity includes the specification of user-modifiable parameters of the system, including child scenario definition, (schedule flight addition, deletion and change, revenue management protocols, distribution agent/airline/location alignment), and editing of the OD demand matrix. A scenario is a database that may contain substantially all the pertinent information about the world's passenger airline network, including, for example, operating airline, schedule (departure and arrivals of flights), airline revenue management protocols, carrier alliance arrangements, minimum connect times, and other variables affecting the movement of passengers through the world's airline network. Here the user may set a focus, which determines what kinds of output are initially displayed after the completion of a simulation run. If the editing included changing OD demand values, then control returns to the PCE process to allow creation of an appropriate synthetic population for the altered demand matrix. The Level 2 Logic for these processes is illustrated in FIG. 3.

2.1 Select or create scenario branch: At the outset of this process, the user may choose to operate on an existing scenario, or create a new one. This branch handles that choice.

2.2 Create scenario from parent scenario: Scenarios may be derived as children from a seed scenario. This insures that all scenarios descended that are eligible for comparison are, in fact, comparable, since they are based on the same state of reality contained in the seed scenario. Users may create child scenarios, and children of child scenarios, etc. to any extent they wish to organize and capture key changes that are under study. The methods for scenario creation are standard, since the child scenario is simply a copy of the parent.

2.3 Select scenario family and scenario: If an existing scenario is to be used in the analysis, it may be identified here. Selection of a scenario may also identify the family from which it derives, and siblings of the selected scenario are available for comparative analyses.

2.4 Edit select branch: This logic branch is where the user may choose which edit function to engage. The user can engage editing operations repeatedly, so control returns here after each function is complete.

2.5 View/Edit Dsags: Here the user can change the allocation of carriers to dsags, and change the cities and pags (customer base, from the dsag perspective) associated with a specific dsag.

2.6 View/Edit Arasags: Here the user can change the schedules (add, delete, change timing or equipment) for the flights associated with an arasag associated with a carrier, or alter the revenue management protocols a carrier applies to a specific flight or group of flights. Individual flights, groups of flights, flights in a specified market of collection of markets, or flights operated by a specified carrier or group of carriers (such as an alliance) or utilizing a specific airport or group of airports can be modified at the same time.

2.7 View/Edit Market Demands: Here the user can change the mean and standard deviation of the market demand for any entry in the OD matrix. However, if this is chosen, the available synthetic populations may no longer be valid for this OD matrix, and control returns to the synthetic population process in PCE (Process 1.5) for creation of a new synpop. In this case, the PCE process exits and returns to the editing control branch. Notice that the creation of a new synpop has no effect on the scenarios.

2.8 Define Focus: In order to organize the massive amount of output that is produced by an AirVM execution, the user is offered the opportunity to define a focus for an analysis. The focus is the set of output the user is most interested in seeing when the simulation is completed, and those are the results that are initially displayed when a simulation run is finished. The focus can be a flight or set of flights, a carrier or set of carriers, an airport, a city, or a market or set of markets. From the focus results display, the user can move to any of the other outcome report screens and explore the results of a simulation run.

2.9 Edit loop control branch: If OD demand edits were done, control shifts to the Synpop processing step (Process 1.5). If not, it returns to the Edit Select branch.

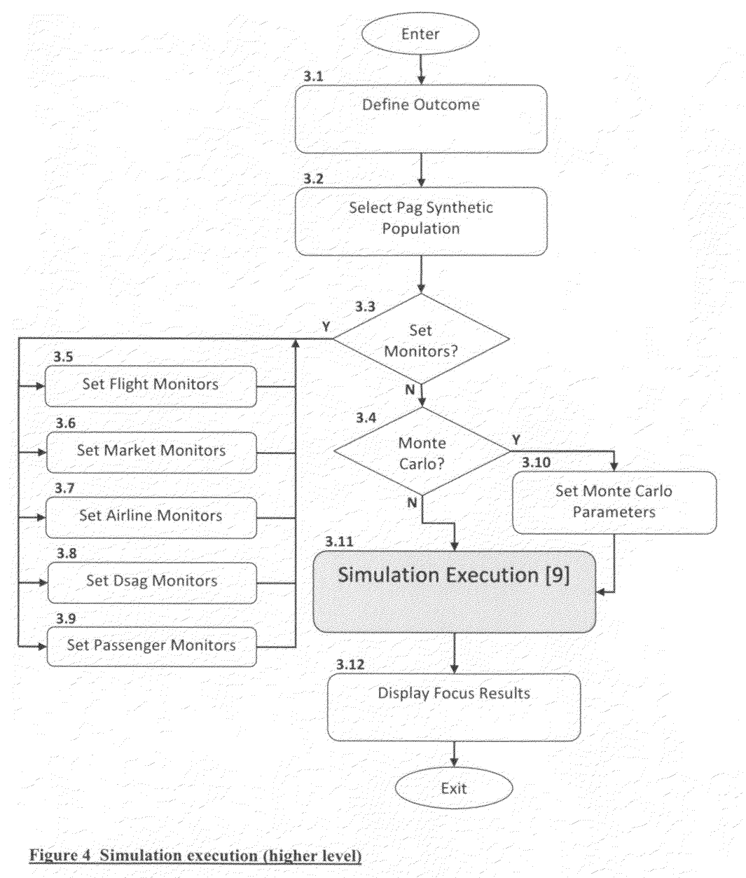

3. Simulation Execution: This process contains the actual tasks associated with the execution of a simulation itself. A simulation run takes a scenario, and applies to it a synthetic population, resulting in the production of an outcome. An outcome is the loading of every passenger that is expected to fly during the simulated time period on every flight operated an may include every scheduled airline in the world. The outcome is a database much like the Scenario, except that the flights may now have manifests of passengers and totals of revenue, from which flight, carrier, market, distribution agent, and various comparative analyses can be performed. FIG. 4 sets out the Level 2 Logic of the simulation execution process.

3.1 Define Outcome: To begin the simulation process the user defines the outcome that will hold the results. There is exactly one outcome per combination of synpop and scenario, except for a Monte Carlo simulation, where there is one outcome for each combination of scenario, synpop, and Monte Carlo simulation cycle.

3.2 Select Synthetic Population: The user may choose a synthetic population from those available for the OD matrix associated with the chosen scenario. The user can also choose to oversample (randomly cause some pags to attempt ticketing more than once) or undersample (randomly cause some pags to be skipped in the ticketing process) in order to easily allow exploration of demand jumps or sharp declines. Oversampling or undersampling can be applied system-wide or to specific ODs or groups of ODs.

3.3 Set Monitors control branch: Monitors are screens that are visible during the simulation to show the status of some part of the scenario during the simulation execution. There are five available monitors, described below, and this branch controls the flow of logic to set up each. The user can invoke as many monitors of each type as he wishes. Each may consist of a window, which displays appropriate data using standard methods. The results shown in any monitor can be saved to a .csv file if desired, for example.

3.4 Monte Carlo control branch: A Monte Carlo simulation is a repeated execution of the same simulation on the same scenario except that some variable in the simulation is varying at random from one cycle of the Monte Carlo to the next. The result is a probability distribution of the values of some of the key variables resulting from the simulation, such as the total revenue generated by the flight. This is a standard form of Monte Carlo simulation. At least two forms of Monte Carlo may be used. One, called inherent variation, is the case where each simulation cycle is exactly like every other one, except that the choice of itinerary is varying according to the probability associated with the discrete choice model. The second is called demand variation, and randomly changes the OD demand for a market or set of markets between simulation runs. The probability distribution found using the Iterative Demand Estimation (Process 1.4) is the basis for the randomly varying demands. The user can also edit the OD demand matrix to set other values of the demand distribution. The results (usually as saved monitor results) may be analyzed externally.

3.5 Set Flight Monitors: The specific flights that the user wants to monitor may be selected here. As tickets are booked on a monitored flight, the monitor may be updated to show the number of tickets, the revenue value, the market being traveled in, if the ticket is cancelled, and so forth.

3.6 Set Market Monitors: All the ticketing activity in a specified market can be monitored, and the display may be updated like the flight monitor as tickets are sold or cancelled.

3.7 Set Airline Monitors: This form of monitor displays changes in the tickets sold by a specified airline.

3.8 Set Dsag Monitors: This form of monitor displays changes in the tickets sold through a given dsag.

3.9 Set Passenger Monitors: Using the sequence number of the pag, a screen will display when a specified pag purchases a ticket (if it can), or when it cancels. The available itineraries from which it can choose are shown, along with the respective probabilities, as well as the details of the discrete choice model used and the itinerary chosen.

3.10 Set Monte Carlo Parameters: If a Monte Carlo simulation is desired, this step is where users may set the parameters of that simulation. The number of iterations of the simulation is established, and the type of Monte Carlo is fixed. If a demand variation simulation is to be done, the ODs in which demands are to vary are also designated. Monte Carlo simulations allow the storage of only monitors, to save storage space, since otherwise a complete outcome would be saved for each iteration, and that could amount to several hundred gigabytes of data. This option is set here as well. As noted above, analysis of Monte Carlo results may be done outside of AirVM.

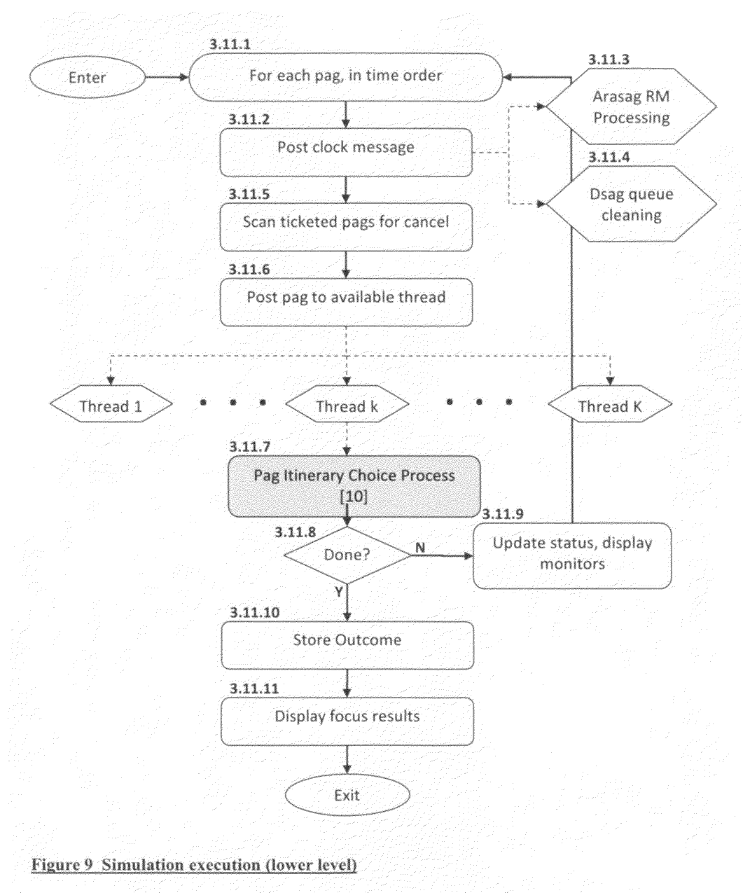

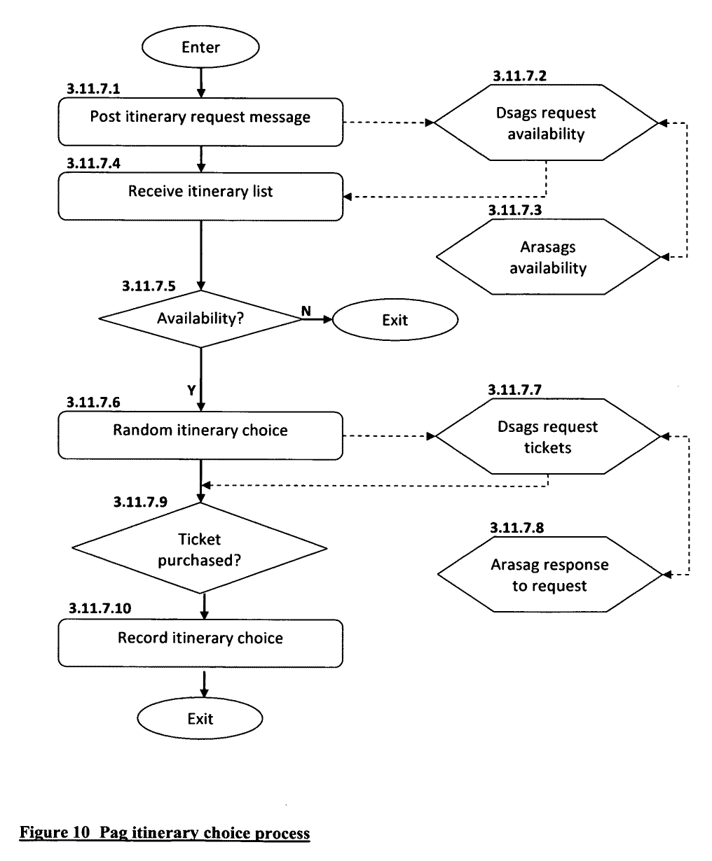

3.11 Simulation Execution: This is the process that contains the actual execution of the simulation. It is described in detail below. The simulation takes some time to execute, depending on the hardware configuration supporting the system. As a benchmark, a single Intel quad processor can produce a single simulation with approximately 45,000,000 pags—representing about 60,000,000 passengers—in approximately 45 minutes. The simulation architecture uses ticketing instant as the simulation clock. The use of this feature can reduce simulation execution time by over 95%. During the execution, the user can pause and restart the simulation (to study a monitor, perhaps) or abort the simulation (in case something was mis-specified). FIG. 9 shows the Level 3 Logic of step 3.11. [Note: In FIG. 9 and FIG. 10, which describes the pag itinerary choice methodology, hexagonal boxes are used to designate processes under separate control of other agents. Communications between autonomous objects is shown with a dashed line.]

3.11.1 Pag ticketing process control loop: Each pag is loaded sequentially from the disk and processed semi-independently of the others. The number of pags that can be processed simultaneously depends on the number of processor threads available. One pag occupies a single thread, and once assigned to a thread, each thread runs independently of the others, except for semaphore-based interaction with the scenario during availability and ticketing. The processing may not be simultaneous, however, since the assignment of pags to threads may occur in ticketing instant order.

3.11.2 Post clock message: The ticketing instances of the pags acts as the simulation clock. The pags, arasags and dsags communicate with each other using the message/event protocols provided by the computer operating systems. They may be standalone objects that function in separate threads, so the messaging process is well defined. Both the arasag and dsag execute activities depending on the time. Arasags, for example, usually execute RM protocols every few hours, or daily (in simulated time). Dsags may clean ticketing request queues periodically (daily) to prevent lockout. Normally, these processes would be governed by an external system clock. In AirVM, this clocking function is provided by the ticketing instant. This is substantially more efficient than an external clock, and has no effect on simulation logic, since everything is driven by passenger action. This characteristic may be extended to other agent models.

3.11.3 Arasag RM Processing: The arasag agents in AirVM execute their RM protocols periodically, and this process may occur here. The exact procedure depends on the specific protocol.

3.11.4 Dsag queue cleaning: Dsags maintain the communications between pag and arasag, and during the normal operations of the simulation the message queues can get corrupted by the asychronicity of the messaging process. Periodically, the dsags may empty the message queues as a housekeeping function. This is handled in this operation.

3.11.5 Scan ticketed pags for cancellation: All pags that have purchased tickets may be processed through the cancellation algorithm to see if they are cancelled. If the cancellation occurs, the pag is posted to an available thread so that cancellation notification can occur.

3.11.6 Post pag to available thread: This process is a scheduler that monitors the available threads and sends the current pag to the first one available. Once the pag has been posted to a thread, control passes to the pag ticketing loop exit control (3.11.8) and, if more pags are waiting for ticketing, the next pag is prepared for processing. If all pags have been processed, the post function waits until the last thread is complete, and then passes control to the exit control, which exits the loop and passes control to 3.11.10.

3.11.7 Pag Itinerary Choice Process: In this procedure, the pag requesting tickets interacts with the dsag, which in turn interacts with the arasags. The logic of this process is central to the operation of AirVM, and is described at Logic Level 4 in FIG. 10.

3.11.7.1 Post Itinerary Request Message: The pag posts a message with the dsag indicating it wants a fixed number of tickets in the specified market at or below a set willingness-to-pay threshold. It also indicates if it is a business or leisure trip, if the pag is arrival or departure time sensitive, and the ideal times for the pag.

3.11.7.2 Dsags request availability: The dsag takes the pag request and identifies the itineraries in the market which meet the pag's requirements. A fixed number of possible itineraries are identified. That number can be set by the user. The dsag then posts messages to the affected arasags requesting availability of tickets. The dsag accumulates the arasag response messages and, when all have responded, packages them up and posts them to the pag message queue.

3.11.7.3 Arasags availability response. The arasags examine the flights requested and respond to the dsag with an availability message.

3.11.7.4 Receive itinerary list: The pag retrieves the itinerary list posted by the dsag, and examines it for availability.

3.11.7.5 Availability branch: If there is no availability for the desired travel, the pag records that fact and exits the thread. Availability may not exist if there is no room on a flight or if no flight meets the pags willingness-to-pay threshold.

3.11.7.6 Random Itinerary Choice: Using the discrete choice random utility function of the pag, the probability of each available itinerary may be calculated, and then a random number generator may be used to select one of the itineraries for ticket purchase. The chosen itinerary is then posted to the dsag message queue.

3.11.7.7 Dsag requests ticketing: The dsag posts a message to the carriers operating flights in the chosen itinerary requesting tickets. Carriers operating flights in itineraries that are not chosen are also notified, so that reserved seats can be released if that is the practice of the arasag. The dsag then awaits response by the carriers. If purchase confirmation is received, the appropriate message is posted to the pag message queue. If, on the other hand, availability is no longer available, a message to that effect is posted.

3.11.7.8 Arasags respond to purchase request: The carriers determine if seats are still available for the requested flights (they could have been taken by in intervening pag operating in another thread), and returns an appropriate message to the dsag.

3.11.7.9 Ticket purchased branch: If the ticket purchase is not confirmed, control returns to the pag itinerary request process (3.11.7.1), and the request process is repeated. If not, the ticketing process moves to completion.

3.11.7.10: Record choice: The chosen itinerary is recorded for this pag, and the thread exits.

3.11.8: Pag loop exit control: If all pags have been processed, the simulation is complete, and the wrap-up processing begins. If not, control is passed to the monitor update task.

3.11.9: Update status, display monitors: The status bar on the simulation control screen is updated, and the monitors, if any, are updated with the relevant new data.

3.11.10: Store Outcome: The result of the simulation, contained as the outcome data set, is written to permanent storage. Standard procedures are used.

3.11.11: Display focus results: The results from the outcome that are defined in the focus of the scenario are now displayed. This signals the completion of the simulation, and the user can move from the focus displays to drill deeper into the simulations results.

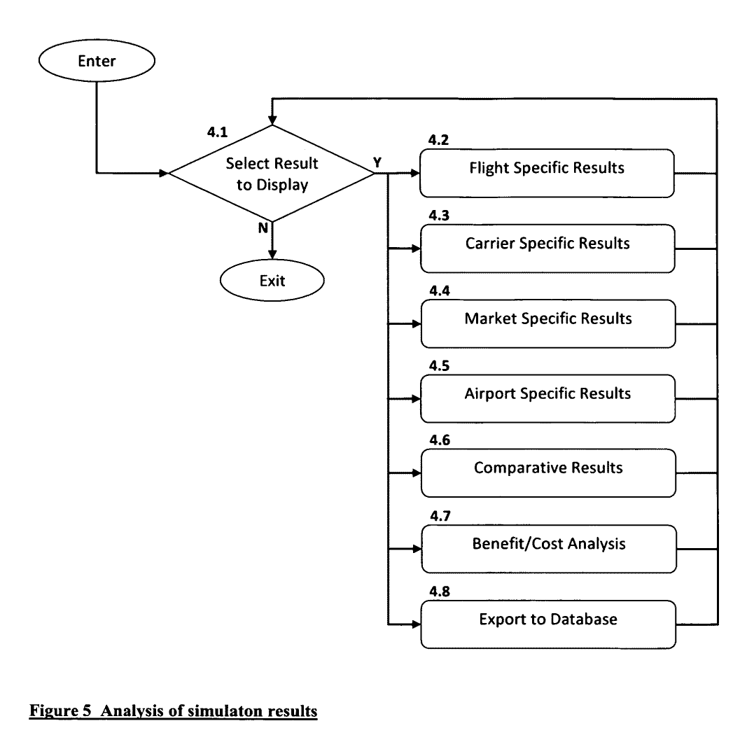

4. Analysis of Simulation Results: This set of processes include a number of standard screen formats to display the results contained in the Outcome of a simulation run, or to compare the results of two or more runs. The user can examine the results, starting from the focus report, as he wishes, drilling down to such detail as necessary. The user can also use the analysis results to design new scenarios. The user can also open AirVM, select a scenario, and if one or more outcomes exist for that scenario, move directly to the focus results displays and proceed to execute any of these analyses. All displays can save the results as text or .csv files for analysis with other programs. The architecture of this process is straightforward and uses standard methods. FIG. 5 shows its Level 2 Logic.

4.1 Result Display branch: This represents the display choice of the user. Control returns here for additional selection until the user exits.

4.2: Flight Specific Results: These displays show the loads and revenues for selected flights, all flights operated by a selected carrier, or all flights out or into a selected airport. Complete details of the flight—loads by cabin and fare class, revenue by cabin and fare class, and load factors and yield data are displayed. In addition, upline, midline, downline and local loads are identified.

4.3: Carrier Specific Results: These displays show the loads and revenue results for itineraries which contain flights operated by one or a specified collection of carriers. In addition to data as discussed in 4.2, load and revenue share information is also provided.

4.4: Market Specific Results: These displays show the itineraries used in a specified market. Data like that mentioned previously is portrayed, but load and revenue share for each itinerary are also shown.

4.5: Airport Specific Results: For a specified airport, the flights in and out of that airport are displayed as a function of the operating week. Dwell numbers—the number of individuals in the airport waiting to board, in the process of changing flights, or deplaning and departing the airport are also shown as a function of time of day.

4.6: Comparative Results: A series of displays stand flight, carrier, or market results of two sibling (comparable) scenario outcomes side by side so the user can compare the effects of one or more changes to a scenario.

4.7: Benefit/Cost Analysis: This result display accepts cost data (in a general form) from the user and then shows the benefit/cost ratio of individual flights, itineraries, markets or carriers.

4.8: Export to Database: This operation writes the outcome of a simulation to an external database in MS-SQL format. Other database structures can then be supported from this common structure.

As will be appreciated by the skilled person, details of the above embodiments may be varied without departing from the scope of the present invention.

For example, the described system may be used to simulate the demand for other markets including other transport and service forms (e.g. trains, buses, airports, car rental operations, and hotels).

Many combinations, modifications, or alterations to the features of the above embodiments will be readily apparent to the skilled person and are intended to form part of the invention.

1. A method for simulating a transport environment comprising the steps of:
providing a plurality of transport routes within a transport environment, wherein each transport route has a set of parameters;
providing a plurality of itineraries each having one or more transport routes selected from the plurality of transport routes and itinerary properties including the parameters of the one or more transport routes within the itinerary;
providing a plurality of software agents corresponding to passengers, the software agents including an itinerary selector configured to select one of the plurality of itineraries based on a comparison of the itinerary properties and a set of passenger requirements; and
outputting information describing the simulated transport environment following selection of itineraries by the software agents.

2. The method of claim 1, wherein the set of passenger requirements and/or itinerary properties is selected from one or more of the group consisting or: number of passengers in a group travelling together, cost, carrier, class, departure time, arrival time, travel time, frequent flyer scheme affiliation, trip purpose, number of transport routes in an itinerary, non-stop itinerary, time to select an itinerary, number of tickets available for each transport route and ticket flexibility.

3. The method of claim 1, wherein the transport environment is selected from the group consisting of: air, bus, shipping, cargo, automobile and rail.

4. The method of claim 1 further comprising a plurality of software agents corresponding to itinerary suppliers arranged to provide the passenger software agents with a selection of itineraries.

5. The method of claim 1, wherein the providing the plurality of transport routes step further comprises: receiving data describing transport routes from more than one source.

6. The method of claim 1, wherein the providing the plurality of itineraries step further comprises the steps of:
sorting the plurality of transport routes according to departure time to form a departure set; and
sorting the plurality of transport routes according to arrival time to form an arrival set.

7. The method of claim 6, further comprising the step of: matching a transport route from the departure set with a transport route from the arrival set by comparing the destinations of the departure transport routes with the origins of the arrival transport routes.

8. The method of claim 7, further comprising the step of: matching further transport routes to form two or more stop itineraries.

9. The method of claim 7 further comprising the step of sorting the itineraries by overall travel time.

10. The method of claim 8 further comprising the step of: determining the lowest number of transport routes for each itinerary origin and destination combination and removing from the plurality of itineraries, itineraries having more than the lowest number of transport routes for the same itinerary origin and destination.

11. The method of claim 7, further comprising the step of: combining itineraries to form further itineraries.

12. The method of claim 1, further comprising the step of sorting the itineraries by itinerary properties.

13. The method of claim 12, wherein the sort is based on a weighted contribution from two or more itinerary properties.

14. The method of claim 1 further comprising the step of determining the cost for each itinerary based on a cost distribution.

15. The method of claim 14, wherein the cost distribution is an empirical distribution function, EDF.

16. The method of claim 1 further comprising the step of determining the cost for each transport route based on a user determined revenue management protocol.

17. The method of claim 1, wherein the itinerary selector is further configured to select itineraries based on historical data.

18. The method of claim 17, wherein the historical data is previous booking information.

19. The method of claim 1, wherein each itinerary having the same itinerary origin and itinerary destination has an associated probability of being selected by the itinerary selector.

20. The method of claim 1 further comprising the step of calculating when more than a certain proportion of the itineraries in each set of itineraries having the same itinerary origin and itinerary destination will be selected by the itinerary selectors of the software agents.

21. The method of claim 1 further comprising the step of randomly generating the set of passenger requirements for each software agent.

22. The method of claim 1 further comprising the step of storing the itineraries selected during a simulation interval.

23. The method of claim 1 further comprising the step of storing outcomes of a simulation, wherein the outcomes are any one or more selected from the group consisting of: seats taken for each flight or carrier, revenue for each flight or carrier, profitability for each flight or carrier, number or transport routes for each origin and destination and itinerary suppliers used.

24. The method of claim 1 further comprising the step of repeating the simulation with different itinerary properties and/or passenger requirements and generating a probability distribution of the output information for each simulation.

25. The method of claim 1 further comprising the step of monitoring each transport route during simulation of the transport system.

26. The method of claim 25, wherein the monitoring step further comprises monitoring values selected from the group consisting of: the number of tickets booked, revenue value, profitability and cancellations.

27. The method of claim 1 further comprising clocking the simulation against the selection of itineraries.

28. The method of claim 1, wherein the plurality of transport routes are substantially all of the worldwide transport routes for one transport type.

29. A method of generating itineraries for a transport environment comprising the steps of:
providing a plurality of transport routes within a transport environment;
ordering the plurality of transport routes according to departure time to form a departure set;
ordering the plurality of transport routes according to arrival time to form an arrival set; and
matching a transport route from the departure set with a transport route from the arrival set by comparing the destinations of the departure transport routes with the origins of the arrival transport routes.

30. The method of claim 31, further comprising the step of: matching further transport routes to form two or more stop itineraries.

31. A computer program product comprising instruction steps for operating on a computer to simulate a transport environment, the instruction steps comprising:
providing a plurality of transport routes within a transport environment, wherein each transport route has a set of parameters;
providing a plurality of itineraries each having one or more transport routes selected from the plurality of transport routes and itinerary properties including the parameters of the one or more transport routes within the itinerary;
providing a plurality of software agents corresponding to passengers, the software agents including an itinerary selector configured to select one of the plurality of itineraries based on a comparison of the itinerary properties and a set of passenger requirements; and
outputting information describing the simulated transport environment following selection of itineraries by the software agents.
